(19) United States
(12) Patent Application Publication
(10) Pub. No.: US 2014/0313346 A1
(43) Pub. Date: Oct. 23, 2014

(54) TRACKING SHOOTING SYSTEM AND METHOD

(71) Applicant: AVer Information Inc., New Taipei City (TW)

(72) Inventors: Chung-Wei HUANG, New Taipei City (TW); Yu-Chi WU, New Taipei City (TW); Cheng-Cheng YU, New Taipei City (TW)

(73) Assignee: AVer Information Inc., New Taipei City (TW)

(21) Appl. No.: 14/180,336

(22) Filed: Feb. 13, 2014

(30) Foreign Application Priority Data
Apr. 17, 2013 (TW) 102113614

(51) Int. Cl. H04N 5/232

(52) U.S. Cl. CPC H04N 5/23203
USPC 348/169

(57) ABSTRACT

A tracking shooting system and method are disclosed herein. The tracking shooting system includes a camera device, a wireless radio frequency module, a wireless transceiver and a control module. The wireless radio frequency module is mounted beside a target area. The wireless transceiver is disposed on an object, and is configured to communicate with the wireless radio frequency module to obtain coordinate information. The control module is configured to receive the coordinate information transmitted from the wireless transceiver, and to calculate a position coordinate of the object in accordance with the coordinate information. The control module controls the camera device in accordance with the position coordinate, so as to tracking-shoot the object.

### RELATED APPLICATIONS

This application claims priority to Taiwanese Application Serial Number 102113614, filed Apr. 17, 2013, which is herein incorporated by reference.

### BACKGROUND

1. Field of Invention

The present invention relates to a camera system. More particularly, the present invention relates to a tracking shooting camera system.

2. Description of Related Art

Certain conference room and lecture recording systems require additional employee for operating a camera to tracking-shoot a speaker in real time. However, such configuration not only wastes valuable resources, but also results in quality variation of the recording.

With the advance of technology, various kinds of automatic tracking shooting lecture systems are developed. The most common automatic tracking shooting method includes a voice tracking control mechanism and an image identification tracking control mechanism.

The voice tracking control mechanism utilizes a voice receiver and a voice recognition to track the position where the speaker speaks, so as to tracking-shoot the lecturer automatically. However, the voice tracking control mechanism may suffer from the interference of noises in the surrounding.

The image identification tracking control mechanism utilizes an image identification to identify the image of the speaker, so as to track the position of the speaker. However, the image identification tracking control mechanism may suffer from the operating variations such as the resolution of the camera, lightning conditions and chrominance of the environment. In addition, these two mechanisms requires higher data processing throughput, which result in advanced requirements on hardware equipments.

Therefore, a heretofore-unaddressed need exists to address the aforementioned deficiencies and inadequacies.

### SUMMARY

One aspect of the present disclosure is to provide a tracking shooting system. The tracking shooting system includes a camera device, a wireless radio frequency module, a wireless transceiver and a control module. The wireless radio frequency module is mounted beside a target area. The wireless transceiver is disposed on an object, and configured to communicate with the wireless radio frequency module to obtain coordinate information. The control module is configured to receive the coordinate information transmitted from the wireless transceiver, and to calculate a position coordinate of the object in accordance with the coordinate information. The control module controls the camera device in accordance with the position coordinate, so as to tracking-shoot the object.

Another aspect of the present disclosure is to provide a tracking shooting method. The tracking shooting method includes following steps: obtaining coordinate information by using a wireless transceiver mounted on an object to communicate with wireless tags mounted at the periphery of a target area; calculating a position coordinate of the object by using the coordinate information; and transmitting the position coordinate to a camera device, so as to make the camera device tracking-shoot the object.

Yet another aspect of the present disclosure is to provide a tracking shooting system. The tracking shooting system includes a wireless transceiver, wireless tags, a control module and a camera device. The wireless transceiver is disposed on an object, and is configured to generate a position signal. The wireless tags are mounted at the periphery of a target area, and each of the wireless tags is configured to transmit a coordinate of a corresponding one of the wireless tags and a signal strength indicator to the wireless transceiver in accordance with the position signal The control module is configured to receive the coordinates of the corresponding wireless tags and the signal strength indicators, and to calculate a position coordinate of the object based on the coordinates of the corresponding wireless tags, the signal strength indicators and a signal strength database. The camera device includes a main camera and a secondary camera. The main camera is configured to shoot the target area in a panorama view. The secondary camera is configured to be controlled by the control module to shoot an area corresponding to the position coordinate, so as to tracking-shoot the object.

In summary, the present disclosure has significant advantages and performance compared with the prior art. The present disclosure has significant technology progress and high value in this industry. The tracking shooting system of the present disclosure performs the operations of tracking shooting with radio-frequency technology, which is able to achieve high accuracy of tracking shooting in most environments.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a tracking shooting system in accordance with one embodiment of the present disclosure;

FIG. 2A is a schematic diagram of a tracking shooting system in accordance with one embodiment of the present disclosure;

FIG. 2B is a schematic diagram of a signal strength database in accordance with one embodiment of the present disclosure;

FIG. 2C is a schematic diagram illustrating calculation of the position coordinate of the object in accordance with one embodiment of the present disclosure;

FIG. 2D is a schematic diagram illustrating calculation of the position coordinate of the object in accordance with another one embodiment of the present disclosure;

FIG. 3A is a schematic diagram of a camera device in accordance with one embodiment of the present disclosure;

FIG. 3B is a schematic diagram illustrating an image shot by the main camera before calibration in accordance with one embodiment of the present disclosure;

FIG. 3C is a schematic diagram illustrating an image shot by the main camera after image calibration in accordance with one embodiment of the present disclosure;

FIG. 3D is a schematic diagram illustrating the image calibration of the secondary camera in accordance with one embodiment of the present disclosure; and

FIG. 4 is a flow chart of a tracking shooting method in accordance with one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Although the terms “first,” “second,” etc., may be used herein to describe various elements, these elements should not be limited by these terms. These terms are used to distinguish one element from another.

In this document, the term “coupled” may also be termed as “electrically coupled”, and the term “connected” may be termed as “electrically connected”. “Coupled” and “connected” may also be used to indicate that two or more elements cooperate or interact with each other.

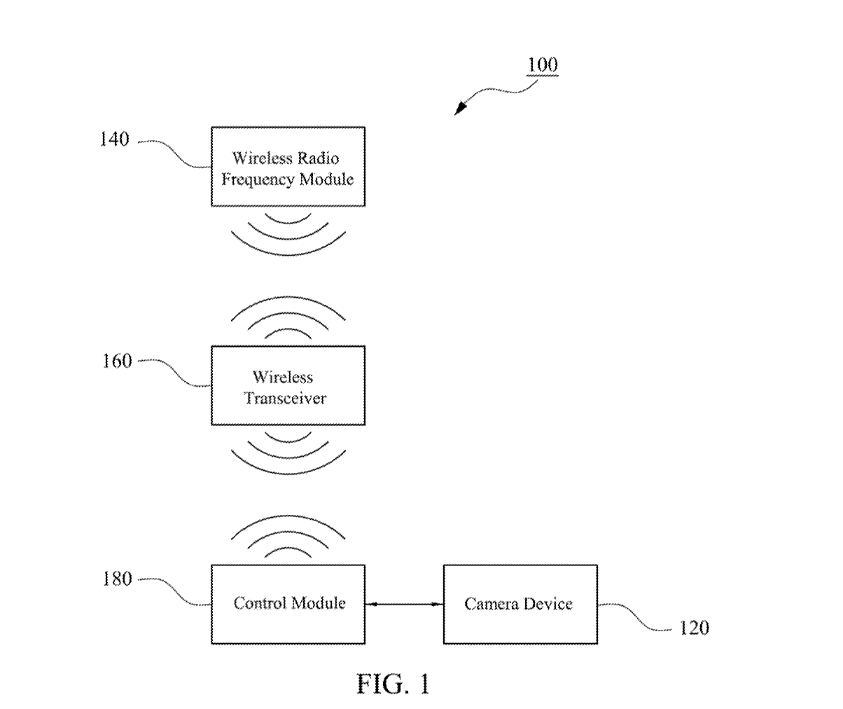

Reference is made to FIG. 1. FIG. 1 is a schematic diagram of a tracking shooting system in accordance with one embodiment of the present disclosure. As shown in FIG. 1, the tracking shooting system 100 includes a camera device 120, a wireless radio frequency module 140, a wireless transceiver 160 and a control module 180.

The wireless radio frequency module 140 is mounted beside a target area, and the wireless transceiver 160 is disposed on an object for shooting. For illustration, the wireless transceiver 160 is disposed at a speaker's microphone or a laser pointer for presentation.

The wireless transceiver 160 is configured to communicate with the wireless radio frequency module 140 to obtain coordinate information.

The control module 180 is configured to receive coordinate information transmitted from the wireless transceiver 160. The control module 180 calculates a position coordinate of the object in accordance with the aforesaid coordinate information, and controls the camera device 120 in accordance with the object, so as to tracking-shoot the object. For illustration, the control module 180 may be a computer for central controlling or a recording control system, and may communicate with the camera device 120 in wired communications or wireless communications.

The following paragraphs in the present disclosure provide numerous embodiments, which are able to implement the functions and operations of the tracking shooting system 100. However, the present disclosure is not limited thereto.

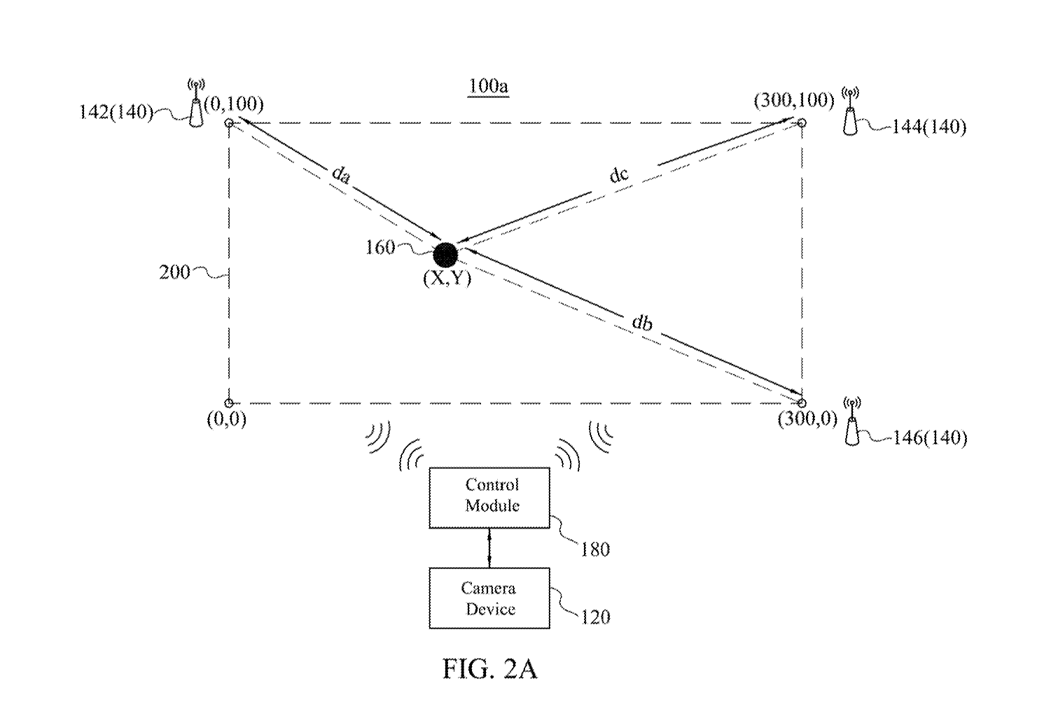

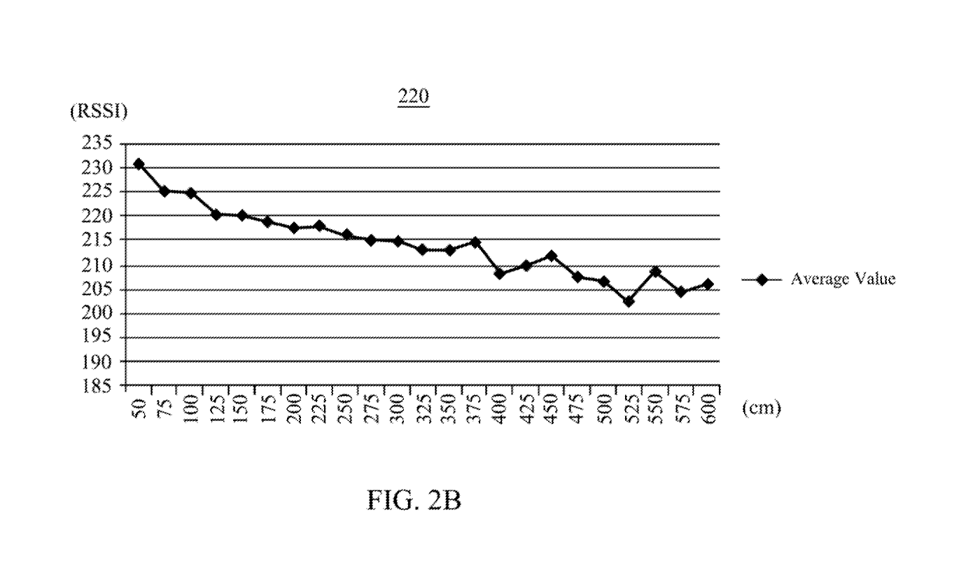

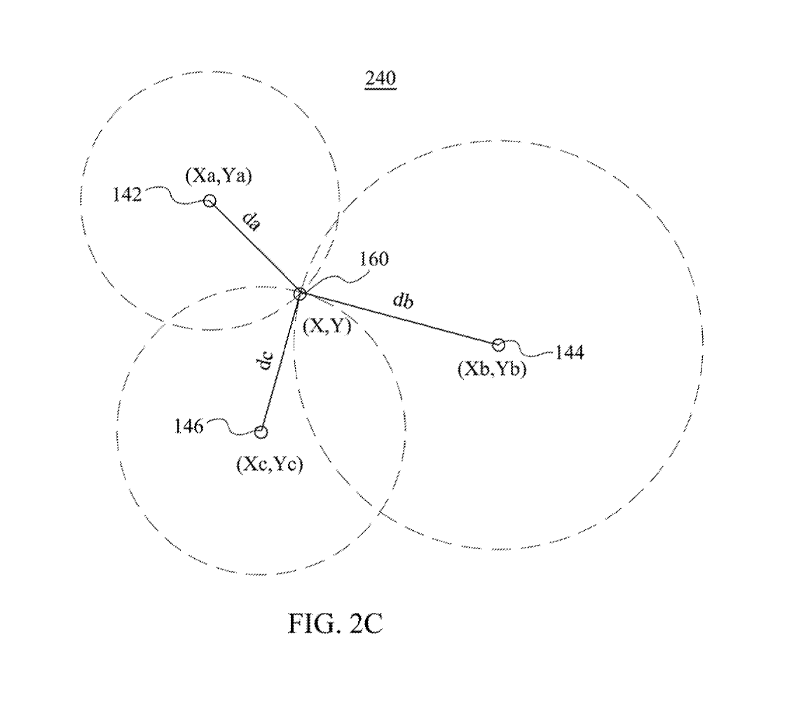

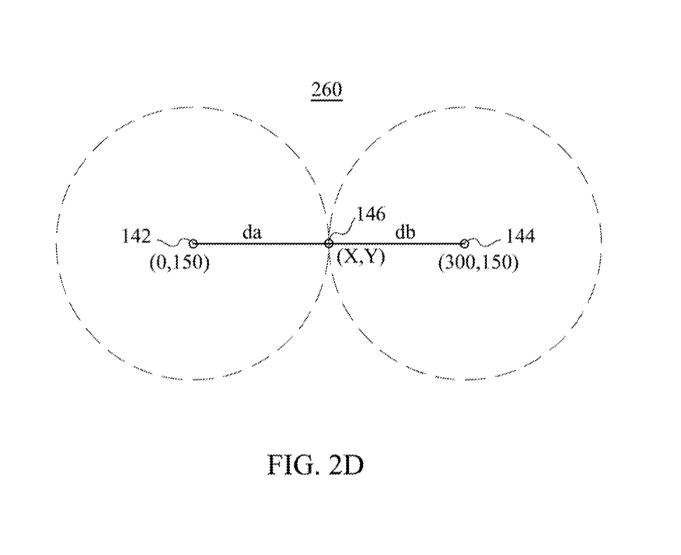

FIG. 2A is a schematic diagram of a tracking shooting system in accordance with one embodiment of the present disclosure. As shown in FIG. 2A, the tracking shooting system 100a includes a camera device 120, a wireless radio frequency module 140, a wireless transceiver 160 and a control module 180.

The wireless radio frequency module 140 includes wireless tags 142, 144 and 146. The wireless tags 142, 144 and 146 may are an electronic device with any types of wireless transmission technology, such as a radio frequency identification (RFID) tag, a Zigbee transmission module, an near field communication (NFC), etc. Person having ordinary skill in the art may choose one of types of the wireless tags in accordance with the size of the target area to be shot or cost of the hardware.

The target area 200 includes a blackboard, a bulletin board, a projection screen, etc. The wireless tags 142, 144 and 146 are mounted at the periphery of the target area 200. For illustration, in this embodiment, the target area 200 is a blackboard being 3 meters wide and 1 meter tall. With such configuration, the coordinates of the four corners of the target area 200 are set to (0,0), (300,0), (0,100) and (300,100), respectively. The wireless tag 142 is mounted at (0,0), the wireless tag 144 is mounted at (300,100), and the wireless tag 146 is mounted at 300,0).

The wireless transceiver 160 is configured to generate a position signal, and each of the wireless tags 142, 144 and 146 is configured to transmit coordinate information back to the wireless transceiver 160.

For illustration, when the transceiver 160 mounted on the object moves to (X, Y), each of the wireless tags 142, 144 and 146, which is mounted around the target area 200, receives the position signal output from the wireless transceiver 160, respectively, and starts to transmit the corresponding coordinate information to the wireless transceiver 160.

Further, in this embodiment, the aforementioned coordinate information include a coordinate of the corresponding one of the wireless tags and a received signal strength indicator (RSSI). For illustration, the coordinate information, which are transmitted from the wireless tag 142 to the wireless transceiver 160, include the coordinate of the wireless tag 142, (0,100), and the RSSI of the position signal received by the wireless tag 142.

In one embodiment, the control module 180 is configured to calculate the position coordinate of the object in accordance with the coordinates of the wireless tags 142, 144 and 146, and each of RSSI.

FIG. 2B is a schematic diagram of a signal strength database in accordance with one embodiment of the present disclosure. Reference is made to both of the FIG. 2A and FIG. 2B. The wireless radio frequency module 140 and the wireless transceiver 160 perform a signal measurement at regular distances, and the received signal strength and the corresponding measurement distance are recorded as the curve in FIG. 2B (i.e., the signal strength database 220) in advance, so as to provide data to the control module 180 for position calculating. For illustration, the distance between the wireless radio frequency module 140 and the wireless transceiver is about 150 centimeters (cm) the crow flies, and the corresponding signal strength is measured at about −50 dBm. The above relationship is record as the signal indicator 220. Alternatively, the distance between the wireless radio frequency module 140 and the wireless transceiver 160 is about 175 cm as the crow flies, and the corresponding signal strength is measured at about −60 dBm. The above relationship is record as the signal indicator 218. Accordingly, the curve in FIG. 2B is able to build by measuring the signal strength at each distance.

Reference is made to FIG. 2C. FIG. 2C is a schematic diagram illustrating calculation of the position coordinate of the object in accordance with one embodiment of the present disclosure.

After the signal strength database 220 is built, the control module 180 is able to calculate the position coordinate of the object. As shown in FIG. 2C, it's assumed that the position coordinate of the object is (X, Y), and the coordinates of the wireless tags 142, 144 and 146 are (Xa,Ya), (Xb,Yb) and (Xc,Yc) respectively. The distance, corresponding to the each of RSSI of the wireless tags, is da, db and dc, respectively. The above information are able to described in the following equation (1):

$$\{ \begin{matrix}\sqrt{{( X - {X}_{a} )}^{2} + {( Y - {Y}_{a} )}^{2}} = {d}_{a} \\ \sqrt{{( X - {X}_{b} )}^{2} + {( Y - {Y}_{b} )}^{2}} = {d}_{b} \\ \sqrt{{( X - {X}_{c} )}^{2} + {( Y - {Y}_{c} )}^{2}} = {d}_{c}\end{matrix} \qquad ( 1 )$$

Further, the control module 180 is able to solve the equation (1) by using matrix formulas or simultaneous equations solver. For illustration, reference is made to both of the FIG. 2A and FIG. 2B, the coordinates (Xa,Ya), (Xb,Yb) and (Xc,Yc) of the wireless tags 142,144 and 146 are (0,100), (300,100) and (300,0), and the corresponding signal strength indicators are 220, 218 and 217, respectively. The control module 180 obtains the corresponding distance are about 150 cm, 175 cm and 200 cm, respectively, from the signal strength database 220. The above parameters are substituted into the equation (1) for solving the position coordinate (X,Y) of the object:

$$\{ \begin{matrix}\sqrt{{( X - 0 )}^{2} + {( Y - 100 )}^{2}} = 150 \\ \sqrt{{( X - 300 )}^{2} + {( Y - 0 )}^{2}} = 175 \\ \sqrt{{( X - 300 )}^{2} + {( Y - 100 )}^{2}} = 200\end{matrix}$$

After the position coordinate (X,Y) of the object is determined by the control module 180, the control module 180 controls the visual angle of the camera device 120 to be moved to the position coordinate (X,Y). Thus, the camera device is able to tracking-shoot the object in real-time.

Reference is made to FIG. 2D. FIG. 2D is a schematic diagram illustrating calculation of the position coordinate of the object in accordance with another one embodiment of the present disclosure.

On the other hand, in a case that only two wireless tags are able to be utilized, these two wireless tags should be mounted on a same horizontal line, and the visual angle of the camera device 120 is thus able to tracking-shoot the object in a one-dimension direction.

For illustration, as shown in FIG. 2D, the position coordinate of the object is (X,Y), the wireless tag 142 is disposed at (0,150), and the wireless tag 144 is disposed ate (300,150). That is, the wireless tags 142 and 144 are disposed at a same horizontal line having a height of 150 cm. Each of signal strength indicators corresponds to the distance da and db, respectively. Similarly, the above information are able to described as the following equation (2):

$$\{ \begin{matrix}\sqrt{{( X - 0 )}^{2} + {( Y - 150 )}^{2}} = {d}_{a} \\ \sqrt{{( X - 300 )}^{2} + {( Y - 150 )}^{2}} = {d}_{b}\end{matrix} \qquad ( 2 )$$

In the equation (2), to simplify the calculation, the common term (Y−150) is able to be removed. The coordinate X is determined by substituting da and db in accordance with the aforesaid signal strength database 200. The control module 180 controls the visual angle of the camera device 120 to be moved to an area corresponding to the position coordinate (X,150) for tracking shooting.

Typically, the positioning is able to be performed with two wireless tags. To maintain a better accuracy, it requires at least three or more wireless tags. Person having ordinary skill in the art may choose a number of the wireless tags in accordance with the practical cases and the size of the target area.

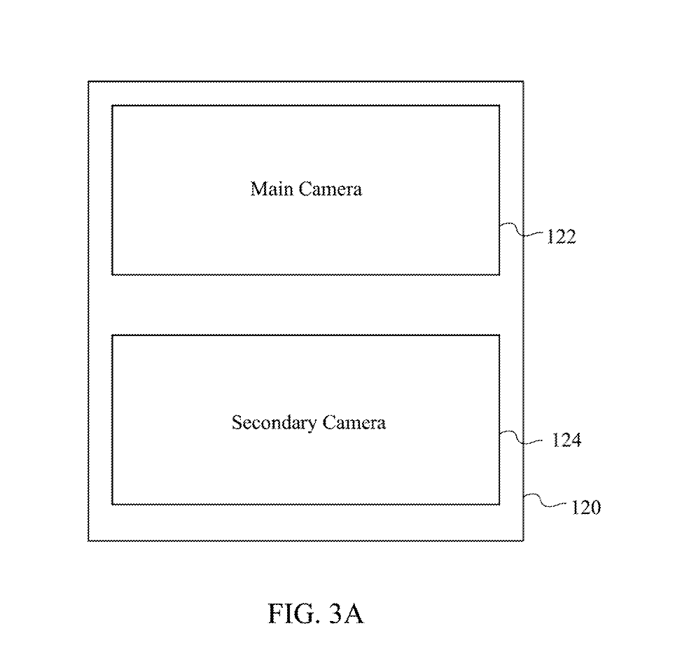

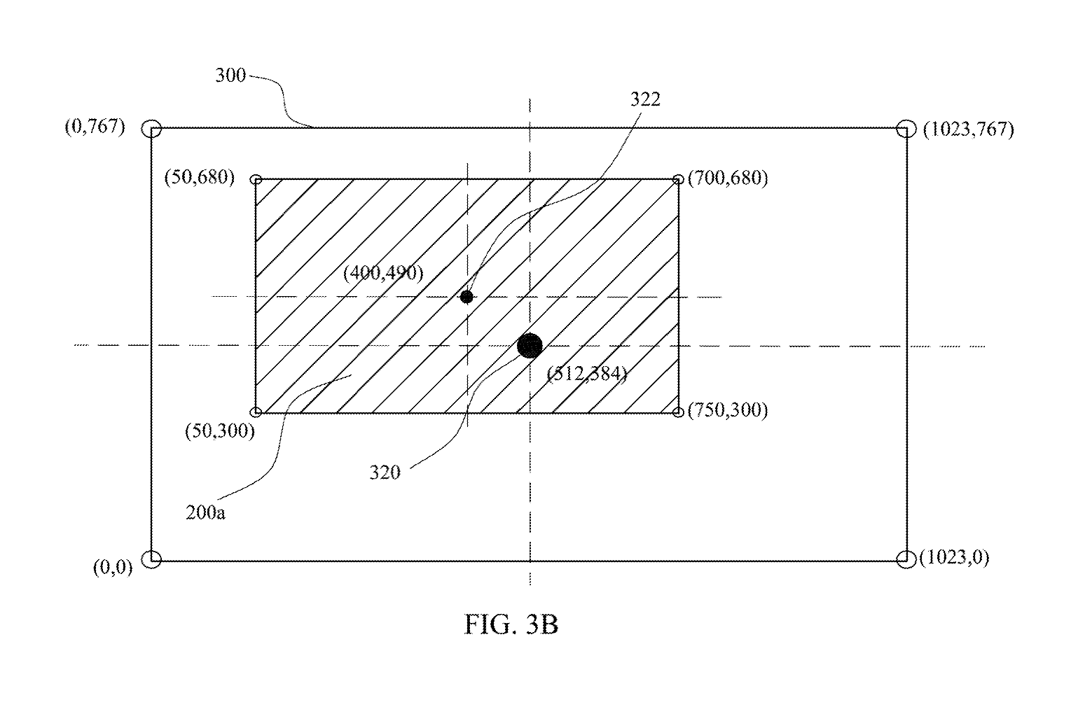

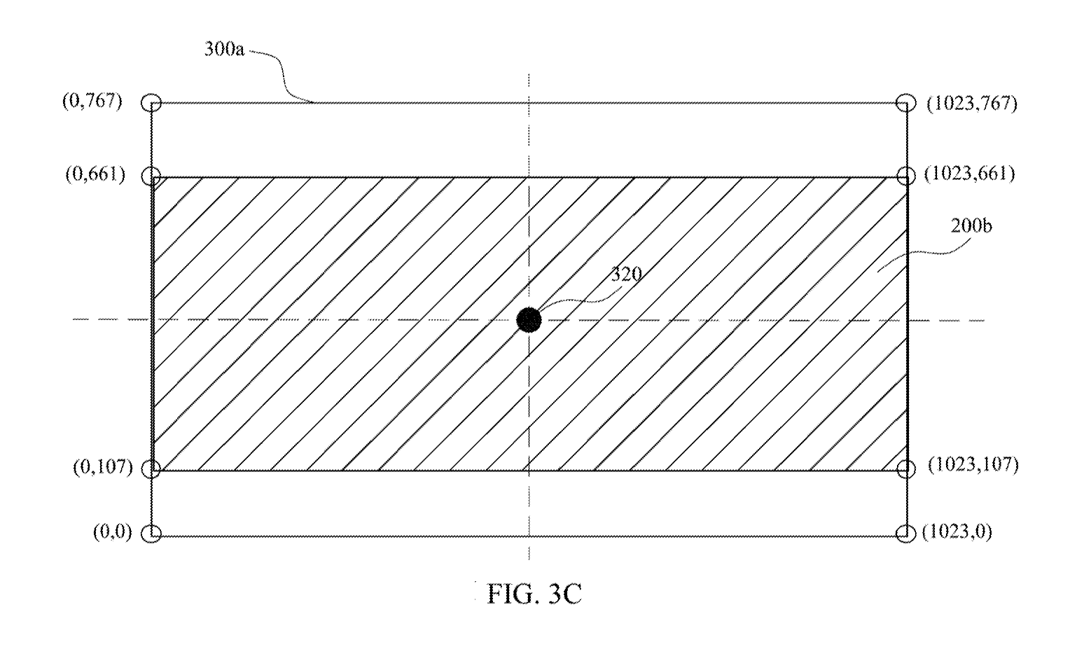

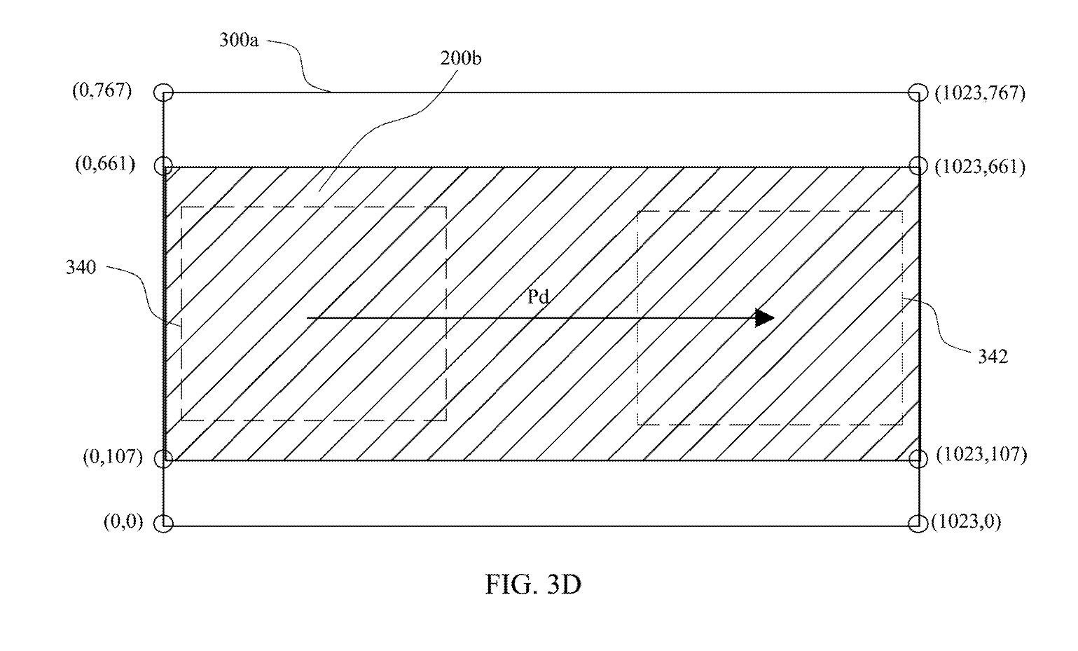

Reference is made to FIG. 3A. FIG. 3A is a schematic diagram of a camera device in accordance with one embodiment of the present disclosure.

In each of embodiments described above, the camera device 120 may include a main camera 122 and a secondary camera 124. The main camera 122 is configured to shoot the target area in a panorama view. In some embodiments, the main camera 122 includes a dome camera or any type of wide-angle cameras.

The secondary camera 124 is configured to be controlled by the control module 180 to tracking-shoot the object. In some embodiments, the secondary camera 124 includes a Pan-Tile-Zoom (PTZ) camera or any types of digital fixed-focus cameras.

Reference is made to FIG. 3B. FIG. 3B is a schematic diagram illustrating an image shot by the main camera before calibration in accordance with one embodiment of the present disclosure.

In some embodiments, the control module is further configured to perform an initial image calibration for the main camera 122 and the secondary camera 124. The purpose of the image calibration is to adjust the image shot by the camera device 200 in accordance with the actual size of the target area.

As shown in FIG. 3B, it's assumed that the solution of the image 300 shot by the camera device 120 is 1024*768, the control module 180 positions four terminals of the image 300 as (0,0), (0,767), (1023,0) and (1023,767), respectively, and the central point 320 of the image 300 is (512,384). When the main camera 122 shoots in the panorama view, the target area 200a in FIG. 3A is shown on the image 300. Then, a system user is able to specify the target area 200a to be shot by using a mouse or touch screen, etc. For illustration, the size of the target area 200a to be shot is 700*380, the system user specifies the target area 200 by selecting on the periphery of the target area 200a, so as to set the size and the position of the target area 200a. After the target area 200a is specified by the system user, the control module 180 positions four terminals of the target area 200a as (50,300), (50,680), (750,300) and (750,680), respectively, and the central point 322 of the target area 200a is (400,900).

In this embodiment, the control module 180 compares the central point 320 of the image 300 with the central point 322 of the target area 200a, and moves the visual angle of the camera device 200a to the upper-left, so as to align the image 300 with the target area 200a to be shot. Thus, the visual angle of the main camera 122 is calibrated.

Reference is made to FIG. 3C. FIG. 3C is a schematic diagram illustrating an image shot by the main camera after image calibration in accordance with one embodiment of the present disclosure.

After compared the size of the image 300 with the size of the target area 200a by the control module 180, the width of the target area 200a is able to be magnified 1.46 times, and the height of the target area 200a is able to be magnified 1.56 times. However, in order to maintain the ration of the target area 200a, the control module may choose to magnify the target area 200a 1.45 times. That is, the target area 200a is magnified as the target area 200b shown in FIG. 3C, and the terminals of the target area 200a is re-positioned, which is illustrated in table.1. Take one of original terminals (50,300) as example, the x-axis coordinate 50 is aligned to the original point of the image 300, and the y-axis coordinate 300 is aligned to 107, which is determined by the y-axis coordinate of the central point 320 and the magnification. That is, 107=384−(384/2*1.46). The calibrated image is shown as the image 300a in FIG. 3C.

TABLE 1
Coordinates of terminals of the target area

| Original coordinates of terminals | Calibrated coordinates of terminals |
|---|---|
| (Target area 200a) | (Target area 200b) |
| (50, 300) | (0, 107) |
| (50, 680) | (0, 661) |
| (750, 300) | (1023, 107) |
| (750, 680) | (1023, 661) |

By using the same calculation, the control module 180 further obtains the coordinates relative to the image of the wireless tags, so as to perform the aforesaid operations of tracking shooting. In addition, the operation of magnified image is able to be performed in optical zoom or digital zoom.

Reference is made to FIG. 3D. FIG. 3D is a schematic diagram illustrating the image calibration of the secondary camera in accordance with one embodiment of the present disclosure.

Take a lecture presentation system as an example, in order to make audiences easier for watching the blackboard or the content on the projection screen, the target area to be tracking shot should be limited in a certain range (e.g., within the platform), rather than tracking shot to the lecturer without limitations.

Therefore in another embodiment, after the main camera 122 is calibrated, the secondary camera is further to be calibrated as well. As shown in FIG. 3D, the size of the image shot by the secondary camera 124 is shown as area 340. When the calibration performs, the system user positions the visual angle of the secondary camera 124 to the left side of the target area 200b, and captures the corresponding static image. Then, the visual angle of the secondary camera 124 is moved to the right side of the target area 200b. The control module 180 checks whether the static image, which is captured earlier, and the image of the right side of the target area 200b (i.e., area 342) are the same by using image identification. After identified, the moveable distance of the secondary distance 124 (i.e., path P_{d}) is thus determined.

In some embodiments, the camera device 120 is further configured to capture a static image of the target area. The wireless transceiver is further configured to generate a capture command to the control module 180, so as to capture the static image.

For illustration, when the lecturer mentions the main points of the speech, the lecturer transmits the capture command to the control module 180 by using the wireless transceiver 160, so as to capture the content on the blackboard or the projection screen instantly. Thus, the audiences are able to record and search the main points more easily after the speech ended.

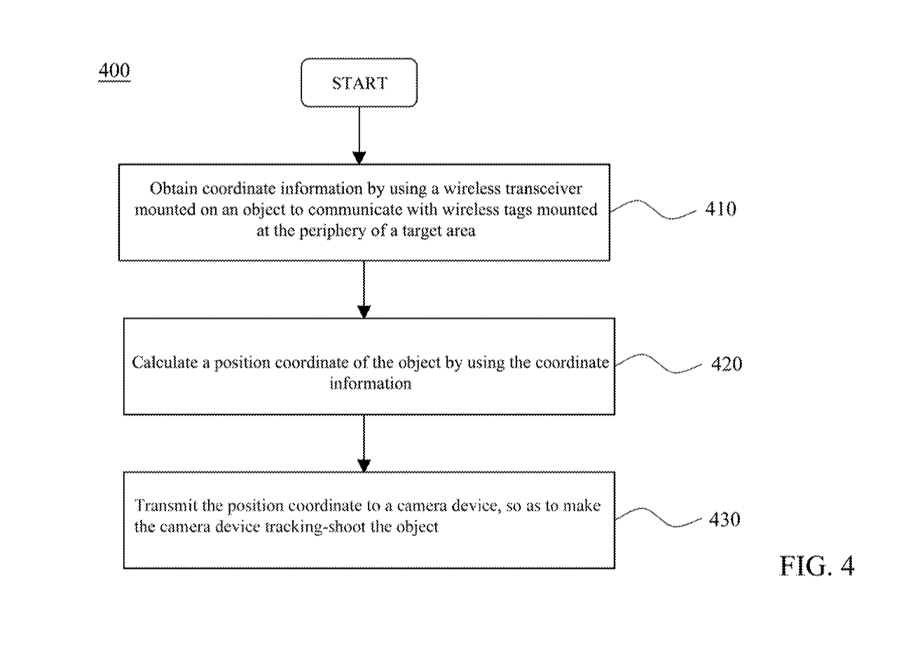

Reference is made to FIG. 4. FIG. 4 is a flow chart of a tracking shooting method in accordance with one embodiment of the present disclosure.

Another aspect of the present disclosure provides a tracking shooting method. As shown in FIG. 4, the tracking shooting method 400 includes operations 410, 420 and 430.

In operation 410 coordinate information are obtained by using a wireless transceiver mounted on an object to communicate with wireless tags mounted at the periphery of a target area. In some embodiments, the coordinate information includes the coordinate of the corresponding one of the wireless tags and signal strength indicators.

In operation 420, a position coordinate of the object is calculated by using the coordinate information. For illustration, as mentioned in the embodiment shown in FIG. 2C, the equation (1) is built in accordance with the coordinate of the corresponding wireless tag, the signal strength indicator, and the signal strength database, and thus the position coordinate of the object is thus determined.

In operation 430, the position coordinate is transmitted to a camera device, so as to make the camera device tracking-shoot the object.

In summary, the tracking shooting system of the present disclosure performs the operations of tracking shooting with radio-frequency technology, which is able to achieve high accuracy of tracking shooting in most environments.

It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A tracking shooting system, comprising:
a camera device;
a wireless radio frequency module mounted beside a target area;
wireless transceiver disposed on an object, and configured to communicate with the wireless radio frequency module to obtain a plurality of coordinate information; and
a control module configured to receive the coordinate information transmitted from the wireless transceiver, and to calculate a position coordinate of the object in accordance with the coordinate information, wherein the control module controls the camera device in accordance with the position coordinate, so as to tracking-shoot the object.

2. The tracking shooting system of claim 1, wherein the wireless radio frequency module comprises:
a plurality of wireless tags mounted at the periphery of the target area.

3. The tracking shooting system of claim 2, wherein the wireless transceiver is configured to generate a position signal, and the wireless tags are configured to receive the position signal and to transmit the coordinate information back to the wireless transceiver.

4. The tracking shooting system of claim 2, wherein each of the coordinate information comprises a coordinate of the corresponding one of the wireless tags and a signal strength indicator.

5. The tracking shooting system of claim 4, wherein the control module is configured to calculate the position coordinate of the object in accordance with the coordinate of the corresponding one of the wireless tags, the signal strength indicator and a signal strength database.

6. The tracking shooting system of claim 3, wherein each of the coordinate information comprises a coordinate of the corresponding one of the wireless tags and a signal strength indicator.

7. The tracking shooting system of claim 6, wherein the control module is configured to calculate the position coordinate of the object in accordance with the coordinate of the corresponding one of the wireless tags, the signal strength indicator and a signal strength database.

8. The tracking shooting system of claim 1, wherein the camera device comprises:
a main camera configured to shoot the target area in a panorama view; and
a secondary camera configured to be controlled by the control module to tracking-shoot the object.

9. The tracking shooting system of claim 8, wherein the control module is further configured to perform a first image calibration for the main camera and the secondary camera.

10. The tracking shooting system of claim 1, wherein the camera device is further configured to capture a static image of the target area.

11. The tracking shooting system of claim 10, wherein the wireless transceiver is further configured to generate a capture command to the control module, so as to control the camera device to capture the static image by the control module.

12. A tracking shooting method, comprising:
obtaining a plurality of coordinate information by using a wireless transceiver mounted on an object to communicate with a plurality of wireless tags mounted at the periphery of a target area;
calculating a position coordinate of the object by using the coordinate information; and
transmitting the position coordinate to a camera device, so as to make the camera device tracking-shoot the object.

13. The tracking shooting method of claim 12, wherein each of the coordinate information comprises a coordinate of a corresponding one of the wireless tags and a signal strength indicator.

14. The tracking shooting method of claim 13, wherein the step of calculating the position coordinate of the object further comprises:
calculating the position coordinate in accordance with the corresponding one of the wireless tag, the signal strength indicator and a signal strength database.

15. A tracking shooting system, comprising:
a wireless transceiver disposed on an object, and configured to generate a position signal;
a plurality of wireless tags mounted at the periphery of a target area, each of the wireless tags being configured to transmit a coordinate of a corresponding one of the wireless tags and a signal strength indicator to the wireless transceiver in accordance with the position signal;
control module configured to receive the coordinates of the corresponding wireless tags and the signal strength indicators, and to calculate a position coordinate of the object based on the coordinates of the corresponding wireless tags, the signal strength indicators and a signal strength database; and
a camera device, comprising:
a main camera configured to shoot the target area in a panorama view;
a secondary camera configured to be controlled by the control module to shoot a area corresponding to the position coordinate, so as to tracking-shoot the object.
